(19) United States
(12) Patent Application Publication
(10) Pub. No.: US 2021/0072103 A1
(43) Pub. Date: Mar. 11, 2021

(54) System for Determining Sitting Position

(71) Applicant: Canyon Bicycles GmbH, Koblenz (DE)

(72) Inventors: Oliver Huth, Worms (DE); Christoph Christophersen, Hamburg (DE); Jonathan Zorn, Hamburg (DE)

(21) Appl. No.: 17/016,463

(22) Filed: Sep. 10, 2020

(30) Foreign Application Priority Data
Sep. 11, 2019 (DE) 20 2019 105 015.2

(51) Int. Cl. G01L 5/22; B62J 45/422; B62J 45/20; B62J 45/41; B62J 45/10; B62J 50/22

(52) U.S. Cl. CPC G01L 5/22; B62J 45/422; B62J 45/20; B62K 21/12; B62J 45/10; B62J 50/22; B62J 45/41

(57) ABSTRACT

A system for determining the sitting position of a cyclist comprises two pressure sensors connected to bicycle-handlebar elements. The pressure sensors are connected to an evaluation device, such as a bicycle computer, via data-transmission devices. Via real-time transmission, the generated data can be directly consumed and integrated in indoor-training software for a realistic training experience. Via the evaluation device, the data obtained by the pressure sensors is evaluated and the sitting position is determined.

### CROSS-REFERENCE TO RELATED APPLICATION

This application claims priority to German Utility Model Application No. 20 2019 105 015.2 filed Sep. 11, 2019, the disclosures of which are hereby incorporated by reference in their entirety.

### BACKGROUND OF THE INVENTION

The invention relates to a system for determining the sitting position of a cyclist.

Particularly when riding bicycles for sport, air resistance has a large influence on speed. Approximately 80% of the air resistance is attributed to the riders themselves, and only 20% to the bicycle. It also should be taken into consideration that, based on the efficiency, the air resistance is the greatest influencing factor on the power transmitted from the rider to the pedals. Therefore, riders participating in cycle racing and middle-distance and long-distance triathlons assume what is known as an “aero position”, in which the rider's posture is as aerodynamic as possible. In cycle racing, the rider grips the lower handlebars of the racing bicycle, i.e. the curved, lower part of the handlebars of the racing bicycle, in the aero position such that their upper body forms the smallest possible working surface or resistance surface for the air. The aero position in a time-trial bicycle, which is used in particular in cycle racing and triathlons, involves the forearms resting on a rest element, known as the arm pads, in the case of triathlon handlebars.

Riders have to be trained to maintain the aero position. At present, this can only be done by the athlete being observed by their coach. In indoor training, for example on stationary bicycles, the correct aero position can again only be observed by the coach.

The object of the invention is to provide a system for determining the sitting position of a cyclist, by means of which the aero position can be detected and evaluated in particular.

This object is achieved according to the invention by a system for determining sitting position having the features of claim 1.

### Description of Related Art

The system according to the invention for determining the sitting position of a cyclist comprises two sensors, in particular designed as pressure sensors, arranged on a bicycle-handlebar element. Additional sensors, for example on the saddle, may optionally be provided. An evaluation device is connected to the sensors. A data-transmission device is provided between the evaluation device and the sensors in order to transmit the sensor data measured by the sensors to the evaluation device. The data-transmission device may be a wired or wireless data-transmission device. The evaluation device may be an external computer, such as a PC, tablet or the like, but may also be a smartphone, or a bicycle computer. The pressure data obtained by the pressure sensors can thus be evaluated by the evaluation device. This is carried out, for example, by comparing the obtained data with stored data, such as a threshold value or target value. The corresponding threshold values or target values can be determined, in particular calculated, for a dependency on rider data, such as weight, height, etc.

In triathlon handlebars, it is preferred for the two pressure sensors to be arranged on the two armrests, i.e. the arm pads. In particular, the pressure sensors may be arranged between two rests, in particular made of elastomer material, in order to prevent any soiling or damage, for example.

In the case of racing-bicycle handlebars, it is preferred for the two sensors, which are in particular pressure sensors, to be provided on the lower handlebars of the racing-bicycle handlebars. In the case of racing-bicycle handlebars, the two sensors are in particular arranged in the region in which the racing-bicycle handlebars are grasped in the aero position.

In a simple embodiment, the data obtained by the sensors can be first collected and evaluated in terms of time, for example, by the evaluation device. From this data alone, it is possible to ascertain changes in the position of the cyclist, for example, in order to identify whether the desired aero position is correctly maintained over the observed time period.

In a particularly preferred embodiment, the evaluation device comprises an evaluation module. Said module serves to evaluate the received sensor data, the evaluation in particular being carried out on the basis of parameters. By means of the evaluation module, the obtained data are thus immediately evaluated, and therefore it can be immediately displayed to a coach or the cyclist whether they are in the correct aero position. The rider or trainer therefore gets immediate feedback on the current position, in particular whether this corresponds to the desired aero position or how much this deviates from the desired position, for example.

For example, a threshold value is specified or calculated on the basis of parameters, which are in particular personal data for the cyclist. If the value measured by the pressure sensors is above the threshold value or is within a predetermined range of deviation around a specified threshold value, this can be defined as the correct aero position. If there is an accordingly greater deviation, the aero position is not assumed, or is not correctly assumed. The personal parameters may in particular be weight, height, etc.

Furthermore, bicycle data, such as frame size, the distance between the saddle and handlebars, the adjustment of the saddle and the like, can be taken into account as parameters during the evaluation by the evaluation module.

Since the system for determining sitting position according to the invention makes it possible to determine the current sitting position, it is also possible to take into account current ride data, such as the incline, speed, course, road surface and the like, as parameters.

Preferably, the evaluation device comprises an output module and/or is connected to an output module. The output module may be a speaker, headphones or a display. In particular, it is the display of a bicycle computer, a smartphone, a tablet or the like. The assessment of the sitting position is preferably output via the output module. For example, it is advantageous here for an output to take place directly on the bicycle computer, such that an athlete receives feedback on their current sitting position straight away while training. As a result, they can train towards the correct aerodynamic sitting position in an improved manner.

It is also possible to recommend a sitting position to the athlete on the basis of parameters. A corresponding recommendation can again be made via the output module, in particular the display of the bicycle computer.

Furthermore, it is possible, by means of the evaluation module, to determine the current sitting position on the basis of the sensor data, in particular taking the parameters into account. This sitting position can then be measured over a time period, such as a training ride, such that an evaluation can be made available to the athlete after training, for example. This can give the athlete a percentage value of the correct sitting position. It can also show them, on the basis of the course, when the sitting position was correct and when it was not. Optionally, a deviation from the sitting position can also be identified and assessed, for example how significant the deviation is. Furthermore, it is possible to determine a sitting-position plan over a time period. Said plan can in particular be determined on the basis of a course.

During indoor training, too, the system for determining the sitting position of a cyclist according to the invention has significant advantages. Using the above-described system, it is possible to train a cyclist to assume a correct aero position. Furthermore, it is possible to simulate the influences of wind, which are based on the sitting position. For example, this can produce an evaluation of the data that is significantly more accurate, since the sitting position has a considerable impact. This is not possible with existing systems. For example, a certain route is simulated using known programs. This simulation can be significantly improved if the influence of the sitting position is also taken into account. In this respect, it is also possible to reproduce and represent a more realistic riding situation during indoor training. By means of the system for determining sitting position according to the invention, the current sitting position can be detected during training and can be displayed to the athlete via a display, in particular in real time. It is also possible to identify the deviation from target data, in which a target/actual comparison is carried out. In this respect, percentage deviations from a target position can be identified and displayed, and/or evaluated, over a training time period, for example. Furthermore, it is possible, in particular on the basis of the speed, incline, course and the like, to recommend to the rider when they should assume or leave the aero position. Since the data obtained by the sensors can be stored, an analysis can be carried out after training. In addition, it is possible to adapt the virtual training environment by means of real-time transmission, in particular in indoor training.

In a development of the invention, it is also possible to provide and evaluate additional sensors. For example, one or more pressure sensors can be integrated in the saddle, such that, in particular, the regions of the saddle in which pressure is exerted can be identified.

In a particularly preferred embodiment, an algorithm, which is in particular integrated in the evaluation device, contains input parameters which determine the logic, such as the training environment, threshold values or plan data. The signal strength of the sensor or the sensor data is used for the output calculation and the position is derived on the basis of the current signal and preferably the historical values. In the system comprising two sensors, the correlation of the values is also interpreted and conclusions are drawn for the output signal. For application in outdoor training, characteristic values are output on the basis of the identified aerodynamic segments and the defined threshold values. For application in indoor training in combination with simulation software, the output signal is used to provide a factor for the simulated speed which may also be dependent on the CdA value (wind-resistance value) of the selected bicycle and/or the height of the rider. As a result, the rider rides more slowly when they are not in the aero position, but rides faster when they are in the aero position, in comparison with a rider who is not using the system and always rides at the same speed regardless of their position.

In the following, the invention is explained in greater detail on the basis of a schematic diagram.

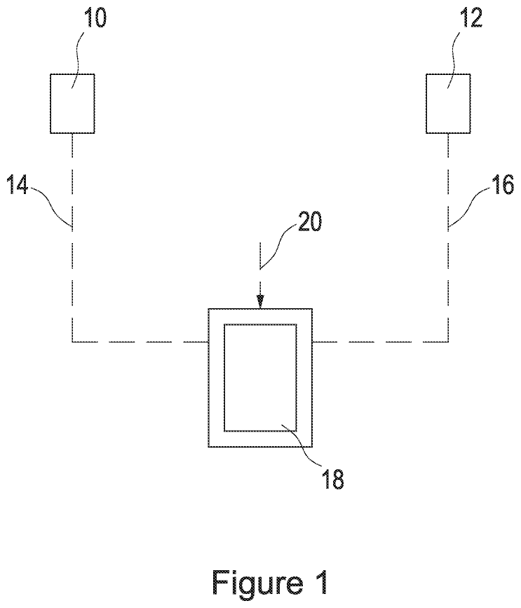

In FIG. 1, the schematic diagram of the system for determining sitting position according to the invention, two pressure sensors 10, 12 are shown schematically. In this case, the pressure sensor 10 can be integrated in a left armrest and the pressure sensor 12 can be integrated in a right armrest. In the same way, the pressure sensors 10, 12 can be arranged in the left and the right lower-handlebar elements, respectively, of racing-bicycle handlebars. The data measured by the sensors 10, 12 are transmitted to a bicycle computer 18, a smartphone, a tablet or the like by means of in particular wireless data-transmission devices 14, 16. In addition, other data can be transmitted to the bicycle computer 18 or the like, in particular also wirelessly, by means of a data-transmission channel 20. Parameters can also be transferred to the bicycle computer 18 or the like by means of said data-transmission channel 20. Parameters of this kind, which are personal data, bicycle data, course data or the like, for example, can be taken into account by the evaluation module integrated in the bicycle computer 18 when determining the sitting position.

1. A system for determining the sitting position of a user comprising:
two sensors, in particular pressure sensors, arranged on a bicycle-handlebar element;
an evaluation device connected to the sensors; and
a data-transmission device connected to the sensors and the evaluation device for transmitting measured sensor data to the evaluation device.

2. The system for determining sitting position according to claim 1, wherein the bicycle-handlebar element comprises two armrests of triathlon handlebars.

3. The system for determining sitting position according to claim 1, wherein the bicycle-handlebar element comprises two lower-handlebar elements of racing-bicycle handlebars.

4. The system for determining sitting position according to claim 1, wherein the data-transmission device is wireless and/or wired.

5. The system for determining sitting position according to claim 1, wherein the evaluation device comprises a bicycle computer, a computer, a smartphone, and/or a tablet.

6. The system for determining sitting position according to claim 1, wherein the evaluation device comprises an evaluation module for evaluating the received sensor data, the evaluation module assessing the sitting position in particular on the basis of parameters.

7. The system for determining sitting position according to claim 6, wherein the parameters include personal data of the user, such as weight and height.

8. The system for determining sitting position according to claim 6, wherein the parameters include bicycle parameters, such as frame size and the distance between the saddle and handlebars.

9. The system for determining sitting position according to claim 6, wherein the parameters include up-to-date ride data, such as speed, incline, and the course.

10. The system for determining sitting position according to claim 1, wherein the evaluation device comprises an output module that is connected to the output module.

11. The system for determining sitting position according to claim 10, wherein the output module is a speaker, headphones, and/or a display.

12. The system for determining sitting position according to claim 6, wherein the assessment of the sitting position is output via an output module.

13. The system for determining sitting position according to claim 6, wherein the assessment of the sitting position includes a recommendation on the sitting position to be assumed.

14. The system for determining sitting position according to claim 6, wherein on the basis of the sensor data and the parameters, the evaluation device determines a current sitting position, determines different sitting positions proportionately over a time period, determines deviations of the current sitting position from a target sitting position, and/or defines a sitting-position plan over a time period.
